(19) United States
(12) Patent Application Publication
(10) Pub. No.: US 2026/0222285 A1
(43) Pub. Date: Jul. 30, 2026

(54) UNIFORM CONFIGURATION METHOD FOR INTEGRATION OF INDUSTRIAL WIRELESS NETWORK AND TIME-SENSITIVE NETWORK

(71) Applicant: CHONGQING UNIVERSITY OF POSTS AND TELECOMMUNICATIONS, Chongqing (CN)

(72) Inventors: Min Wei, Chongqing (CN); Mengfei You, Chongqing (CN); Shuang Niu, Chongqing (CN); Chengjie Huo, Chongqing (CN); Jianjun Wang, Chongqing (CN); Xinyang Yu, Chongqing (CN); Kang Wen, Chongqing (CN)

(21) Appl. No.: 19/145,781

(22) PCT Filed: Dec. 29, 2023
(86) PCT No.: PCT/CN2023/143036

§ 371 Date: Jul. 3, 2025

(30) Foreign Application Priority Data
Jan. 3, 2023 (CN) CN202310009379.1

(51) Int. Cl. H04L 41/0803; H04L 41/0266; H04L 41/12; H04L 41/16

(52) U.S. Cl. CPC H04L 41/0803; H04L 41/0266; H04L 41/12; H04L 41/16

(57) ABSTRACT

The present invention relates to a multi-party semi-supervised learning method for recommending potential users of financial products, and falls within the field of big data recommendation. To address the challenge faced by financial product providers who possess only positive labeled data and thus cannot perform effective customer recommendation, the method conducts multiple rounds of random sampling on unlabeled data from multiple other parties while preserving data privacy and security. Through this process, multiple balanced binary classification datasets comprising both positive and pseudo-negative samples are constructed. Based on each balanced dataset, a vertical federated learning model is then trained using a base estimator. Based on the collective prediction results generated by the vertical federated learning models, reliable positive samples are identified from the unlabeled data. The overall dataset is iteratively updated to repeat the sampling, model training, and prediction processes, enabling the progressive extraction of batches of reliable positive samples. This method effectively supports batch recommendation in scenarios where the party seeking recommendation services possesses only a small number of positive samples while other parties have large volume of unlabeled data. The method significantly improves the reliability, accuracy, and scalability of financial products recommendation to potential users.

### CROSS-REFERENCES TO RELATED APPLICATIONS

This application is the US National Phase Entry of International Application Serial No. PCT/CN2023/143036 filed on Dec. 29, 2022, which claims priority to Chinese Patent Application Serial No. CN202310009379.1 filed on Jan. 3, 2023, which are each hereby incorporated herein by reference in its entirety.

### FIELD OF THE INVENTION

The present invention relates generally to network configuration management, and more particularly to a unified configuration method for integrating industrial wireless network with Time-Sensitive Networking (TSN).

### BACKGROUND OF THE INVENTION

In the context of smart manufacturing environments, industrial sites are often populated with a diverse array of sensors and intelligent devices, leading to the coexistence of multiple industrial wireless networks. As a widely adopted communication technology, industrial wireless networks facilitate the interconnection of field devices via wireless links, offering a cost-effective and highly reliable communication infrastructure for industrial-level operations. With the continuous expansion of industrial systems, there is an increasing demand for flexible, scalable integration with the Industrial Internet of Things (IIOT), as well as for network infrastructures capable of supporting deterministic, low-latency data transmission. In response to such demands, Time-Sensitive Networking (TSN) has emerged as a key enabling technology for next-generation industrial networks. TSN extends conventional Ethernet protocols by introducing deterministic transmission capabilities—such as low latency, minimal jitter, and high reliability—while maintaining full backward compatibility with standard Ethernet. This allows for seamless real-time data exchange across heterogeneous network domains. The convergence of industrial wireless networks with TSN offers the potential to fulfill both flexible connectivity requirements and the stringent communication reliability demands inherent in industrial automation and control systems. Although foundational research has been conducted on hybrid wired-wireless architectures and scheduling mechanisms, practical implementation remains hindered by the heterogeneity of network protocols and configuration paradigms. In particular, the lack of a unified configuration framework for integrating industrial wireless network with TSN remains an open challenge that warrants further investigation.

In the domain of heterogeneous industrial wireless network configuration, prevailing methodologies have predominantly adopted software-defined networking (SDN)-based architectural frameworks (See the literature: Guanghua Ni, Guanghui Wang & Chunhui Zhang “A Software-Defined-Based Design Architecture for Heterogeneous Wireless Networks [J].” Radio Communication Technology, 2020, 46 (3), 300-303). The approach introduces a centralized scheduling mechanism to coordinate transmission resources—such as time slots and frequencies—across heterogeneous wireless networks. This is achieved via the dissemination of flow-table messages to facilitate device management and control, accompanied by an exploration of functional roles and administrative processes within dynamic networking topologies. However, such frameworks generally overlook the issue of configuration heterogeneity at the data plane, namely, how to reconcile the disparate configuration interfaces and capabilities of various wireless devices. Furthermore, most commercial industrial wireless devices lack native support for flow-table-based configuration protocols, thereby rendering such solutions impractical for deployment in real-world industrial settings.

Xiaodong Wu et al., have sought to leverage SDN concepts within wireless sensor networks (WSNs), proposing architectures such as SD-WSN, in which a customized network controller governs node configuration and management through dynamic flow table deployment (See the literature: Wu Xiaodong & Wang Haitao, Exploration of a novel wireless sensor network architecture based on SDN [J]. Data Communication, 2021(01): 1-4). While conceptually promising, these frameworks have thus far remained limited in scope and have not addressed the complexities of large-scale, heterogeneous industrial environments.

Meanwhile, the OPC UA (Open Platform Communications Unified Architecture) protocol has demonstrated considerable potential in enabling standardized information modeling across intelligent production systems (See the literature: A. Chai, Y. Ma, Z. Yin and M. Li, “Real-Time Communication Model Based on OPC UA Wireless Network for Intelligent Production Line.” IEEE Access, vol. 9, 102312-102326, 2021, doi: 10.1109/ACCESS.2021.3097399). By abstracting device data and behaviors into a unified model, OPC UA significantly enhances interoperability and semantic consistency across heterogeneous wireless platforms. However, extant research has primarily emphasized OPC UA's role in facilitating data communication and information modeling. Little attention has been given to its applicability as a foundational mechanism for implementing wireless device configuration in heterogeneous industrial networks.

Further efforts toward the unified control of industrial wireless networks and Time-Sensitive Networking have been exemplified by the work of Böhm et al., who proposed a time-sensitive software-defined networking (TSSDN) architecture that integrates TSN and SDN into a shared control plane (See the literature: Böhm M, Ohms J, Kumar M, et al. “Time-sensitive software-defined networking: A unified control-plane for TSN and SDN [C]//Mobile Communication-Technologies and Applications.” 24. ITG-Symposium. VDE, 2019:1-6). This approach conceptually addresses the unification of control mechanisms across TSN and non-TSN domains. However, while the framework provides valuable insights into high-level network orchestration, it does not adequately address the underlying challenges associated with information exchange and configuration management within heterogeneous networks. In particular, the mechanisms for real-time data interaction, semantic interoperability, and dynamic configuration across diverse device types remain underexplored, limiting the practical applicability of such control-plane unification in industrial settings.

### BRIEF DESCRIPTION OF INVENTION

In view of the foregoing, the objective of the present invention is to provide a unified configuration method for integrating an industrial wireless network with a Time-Sensitive Networking (TSN).

To achieve the above objective, the present invention provides the following technical solution:

A unified configuration method for integrating an industrial wireless network with a Time-Sensitive Networking (TSN), comprising:
S1: establishing a user-plane application for acquiring service traffic information and a network topology;
S2: transmitting the service traffic information from the user-plane application to a control plane via a northbound interface, and retrieving a data-plane network status via the northbound interface;
S3: modeling the service traffic information and the network topology using a unified configuration system, parsing a traffic information model via a scheduling computation module, performing scheduling computation, and obtaining a scheduling result;
S4: designing a network device configuration method for the industrial wireless network and the TSN to enable configuration of network devices in a heterogeneous network;
S5: designing configuration information for the heterogeneous network based on an XML format; and
S6: delivering the configuration information from the unified configuration system to configure the network devices and field devices in the heterogeneous network.

Optionally, S1 specifically comprises: providing an interactive interface in the user-plane application for acquiring the service traffic information and the heterogeneous network topology via manual user input or a user-defined configuration protocol;
wherein the service traffic information comprises a network protocol identifier, the traffic frame length, the traffic period, the jitter constraint, and the delay constraint;
and wherein the user-plane application is further configured to construct the heterogeneous network topology as input condition information for performing the scheduling computation.

Optionally, S2 specifically comprises: establishing a connection between the user-plane application and an industrial software-defined controller in the control plane via the northbound interface, the user-plane application being configured to program, deploy, and configure the heterogeneous network;
wherein the northbound interface is configured to support transmission of the service traffic requirements and retrieval of the network status information from the data plane;
designing the northbound interface of the unified configuration system to satisfy the following requirements:
(1) enabling integration with external software systems;
(2) providing interfaces including a scheduling algorithm selection interface, a scheduling algorithm execution interface, a configuration information query interface, a scheduling result upload interface, a network topology query interface, a service traffic variation notification interface, and a network topology variation notification interface;
wherein an API address prefix is defined as http://localhost:8088, and the northbound interface of the unified configuration system is further configured with:
the scheduling algorithm selection interface identified by /UCS/selectalgo, using a POST request method and a JSON interaction format;
the scheduling algorithm execution interface identified by /UCS/startalgo, using a GET request method and the JSON interaction format;
the configuration information query interface identified by /UCS/queconinfo, using a POST request method and the JSON interaction format;
the scheduling result upload interface identified by /UCS/postconinfo, using a POST request method and the JSON interaction format;
the network topology query interface identified by /UCS/quetopo, using a GET request method and the JSON interaction format;
the service traffic variation notification interface identified by /UCS/streamchange, using a POST request method and the JSON interaction format; and
the network topology variation notification interface identified by /UCS/topochange, using a POST request method and the JSON interaction format.

Optionally, S3 specifically comprises:
(1) modeling the service traffic information:
modeling the service traffic information by using a JSON format in the unified configuration system to construct a service traffic information model; encapsulating a network protocol identifier, a traffic frame length, a traffic period, a jitter constraint, and a delay constraint included in the service traffic information into the service traffic information model, such that the encapsulated model improves semantic interoperability of the unified configuration system;
performing service traffic information modeling by analyzing the service traffic information in the Time-Sensitive Networking and the industrial wireless network; defining the network protocol identifier, the frame length, the period, the maximum jitter, and the delay as “Keys”, and assigning “Values” as attribute values corresponding to the network protocol identifier, the frame length, the period, the maximum jitter, and the delay; wherein the TSN standard classifies traffic into eight priority levels according to traffic type and service requirements, such that TSN-side traffic priority values range from 0 to 7; and the industrial wireless network traffic, based on relevant standards, is divided into multiple priority levels and further includes a superframe length and protocol identifier information.
(2) modeling the network topology:
modeling the network topology by processing the network topology as a directed graph G=(V, E) and storing connection relationships in a JSON format;
wherein each device in the network topology has a unique IP address and is distinguishable via the device IP, and the connection relationships between devices are collected to construct a JSON-based topology model;
wherein parameters in the JSON topology model are defined as follows:
a parameter viewDevLinkList of type string indicating a primary key ID;
a parameter SourceDevIp of type string indicating a source device IP;
a parameter TargetDevIp of type string indicating a target device IP;
a parameter SouDevPort of type Integer indicating a source device port;
a parameter TarDevPort of type Integer indicating a target device port;
a parameter SouDevPortEnable of type string indicating a source port enable state; and
a TarDevPortEnable of type string indicating a target port enable state;
parsing the connection relationships among the network devices to construct the directed graph G=(V, E), where V is a set of nodes and E is a set of edges, to determine a transmission path from a sending end to a receiving end in the network.

Optionally, S4 specifically comprises:
establishing an OPC UA client/server connection between the unified configuration system and the industrial wireless network, modeling the configuration information using an OPC UA protocol, and transmitting data to enable information interaction between the configuration system and devices; establishing an OPC UA client in the unified configuration system and an OPC UA server in an industrial wireless gateway device, wherein the OPC UA server provides an access interface as a service to the OPC UA client, and a connection is established using a UDP protocol to enable information exchange; after deployment of the OPC UA server, performing information exchange between the OPC UA client and the OPC UA server via the OPC UA protocol, and transmitting wireless network configuration information from the unified configuration system to the industrial wireless gateway device.

For configuring the TSN network, performing configuration management of TSN network devices using a NETCONF network management protocol in accordance with IEEE 802.1Qcc standard, and modeling data using a YANG (Yet Another Next Generation) model; establishing a NETCONF connection between the unified configuration system and the TSN network, wherein a NETCONF client and a NETCONF server establish the NETCONF connection via an SSH protocol, the SSH protocol being used to transmit XML-based configuration information; transmitting the XML-based configuration information from the unified configuration system to the TSN network device, verifying and parsing the XML-based configuration information at the NETCONF server, performing corresponding operations to configure the TSN network device, and returning a status message to the NETCONF client.

Optionally, S5 specifically comprises:
industrial wireless network configuration information:
after establishing a gateway device information model, describing the information model using XML to obtain basic information of the gateway device from an XML file, and defining various attribute information as well as reference and inheritance relationships in OPC UA; wherein the information model is configured to support transmission, reading, and writing across different systems, and configuration information is delivered by accessing an externally exposed information interface of the OPC UA server.
(2) The TSN configuration information:
modeling a configuration model for TSN network devices using a YANG model, establishing the network device configuration model, populating the scheduling result into the YANG model by the unified configuration system, and storing and transmitting the scheduling result in an XML format.

Optionally, S6 specifically comprises:
(1) configuring the industrial wireless network devices and field devices:
configuring the industrial wireless network devices and the field devices, wherein the industrial wireless network comprises an industrial wireless gateway device, an industrial wireless routing device, and a field wireless node, and the unified configuration system is configured to perform functional configuration of the three device types to satisfy service traffic transmission requirements;
wherein the industrial wireless gateway device serves as a network device, and the unified configuration system establishes a connection with the industrial wireless gateway device via an OPC UA transmission mechanism to transmit the industrial wireless network configuration information; after receiving the configuration information, the industrial wireless gateway device generates a routing table, a superframe table, and a link table, and transmits configuration information frames to the industrial wireless routing device; the industrial wireless routing device transmits a beacon frame and superframe configuration information to the field wireless node, and the field wireless node performs a superframe configuration task based on the configuration information.
(2) configuring the Time-Sensitive Networking devices and field devices:
configuring the Time-Sensitive Networking devices and the field devices, wherein the TSN devices comprise a switch supporting TSN technical standards, and the switch is configured with a gate control list and a port enablement state; the XML configuration information is transmitted to the switch, and a NETCONF server deployed in the switch verifies and parses the XML configuration information, then performs functional configuration based on the parsed results; a network device in the TSN network forwards field device configuration information to a TSN field device, the TSN field device verifies the configuration information, and if the configuration information is addressed to the TSN field device, the device parses and applies the configuration;
if the configuration information is not addressed to the TSN field device, the information is discarded without processing.

The beneficial effects of the present invention are as follows:
(1) With respect to the configuration of heterogeneous networks composed of industrial wireless networks, existing methods utilize software-defined heterogeneous wireless network architectures and perform network configuration through the delivery of flow-table messages. However, most wireless network devices are not capable of supporting flow-table-based configuration. The present invention provides a configuration method for heterogeneous wireless networks based on OPC UA, and performs network configuration using an XML-standard configuration format, which offers broader applicability.
(2) With respect to the unified configuration method for integrating industrial wireless network with Time-Sensitive Networking, the unified control-plane concept based on TSSDN has not yet considered mechanisms for information exchange and centralized configuration across heterogeneous networks. The present invention proposes a unified configuration architecture for integrating industrial wireless network with TSN, designs the information interaction format between configuration layers, and provides a centralized configuration method for such integration, thereby achieving unified configuration of industrial wireless networks and TSN.
(3) In heterogeneous networks, most existing configuration methods still rely on manual static configuration, often requiring devices to be taken offline during the configuration process, which is typically complex and inefficient. The present invention designs a unified configuration system for heterogeneous networks and introduces a dynamic configuration mechanism. The unified configuration system can automatically update network configuration information in response to changes in the data plane, thereby ensuring that service traffic transmission requirements are met in industrial heterogeneous network scenarios.

Other advantages, objectives, and features of the present invention will be further illustrated in the following description and will, in part, be apparent to those skilled in the art upon reading and understanding this disclosure, or may be learned through the practice of the invention. The objectives and other advantages of the present invention may be realized and attained through the elements and combinations particularly pointed out in the written description that follows.

### BRIEF DESCRIPTION OF THE DRAWINGS

In order to more clearly illustrate the objectives, technical solutions, and advantages of the present invention, preferred embodiments are described in detail below with reference to the accompanying drawings, in which:

FIG. 1 is a schematic diagram of a unified configuration architecture for a heterogeneous network comprising an industrial wireless network and a Time-Sensitive Networking (TSN);

FIG. 2 is a flowchart of a unified configuration scheme for a heterogeneous network integrating an industrial wireless network and a TSN;

FIG. 3 is a flowchart of a dynamic configuration mechanism for a heterogeneous network;

FIG. 4 is a schematic diagram illustrating the configuration of network devices in an industrial wireless network and a TSN;

FIG. 5 is a diagram of a gateway device information model in the industrial wireless network.

### DETAILED DESCRIPTION OF THE INVENTION

The embodiments of the present invention are described in detail below with reference to specific examples. Other advantages and effects of the invention will be readily understood by those skilled in the art based on the contents disclosed herein. The present invention may also be implemented or applied in alternative forms of embodiments, and various modifications or alterations may be made to the details described herein from different perspectives and for different applications, without departing from the spirit of the invention. It should be noted that the drawings provided in the following embodiments are merely illustrative of the basic concept of the invention. Unless otherwise indicated, the features of the following embodiments may be combined with one another where there is no conflict.

The accompanying drawings are provided for illustrative purposes only and are schematic in nature. They are not physical representations and should not be construed as limiting the invention. For clarity, certain components in the drawings may be omitted, enlarged, or reduced, and do not necessarily reflect actual product dimensions. It will be understood by those skilled in the art that certain known structures and their descriptions may be omitted from the drawings.

In the drawings of the embodiments of the present invention, identical or similar reference numerals refer to identical or similar components. As used in the present description, it should be understood that terms such as “upper,” “lower,” “left,” “right,” “front,” and “rear,” where used to describe directional or positional relationships, refer to the orientation shown in the drawings. These references are provided solely for the purpose of simplifying and clarifying the description of the invention, and do not indicate or imply that the referenced devices or components must be constructed or operated in a particular orientation. Accordingly, such directional terminology should not be construed as limiting the scope of the invention, and one of ordinary skill in the art will understand how to interpret these terms in view of the specific context.

### 1. Unified Configuration Architecture for a Heterogeneous Network Integrating an Industrial Wireless Network and a Time-Sensitive Networking:

The Industrial Internet of Things (IIOT) continuously integrates various sensors or controllers with sensing and monitoring capabilities, as well as technologies for information communication and intelligent analysis, into all stages of industrial production. This integration enhances manufacturing efficiency, and the optimization of unified configuration technologies for both wired and wireless networks has become a key evolutionary trend in field-level IIOT systems. How to execute unified configuration for heterogeneous networks with high efficiency and high quality—while ensuring low-latency and deterministic transmission of different types of data within industrial heterogeneous networks—is of critical importance. Accordingly, research into unified configuration methods for industrial heterogeneous networks, particularly those adapted to meet field-level service traffic requirements, is highly significant.

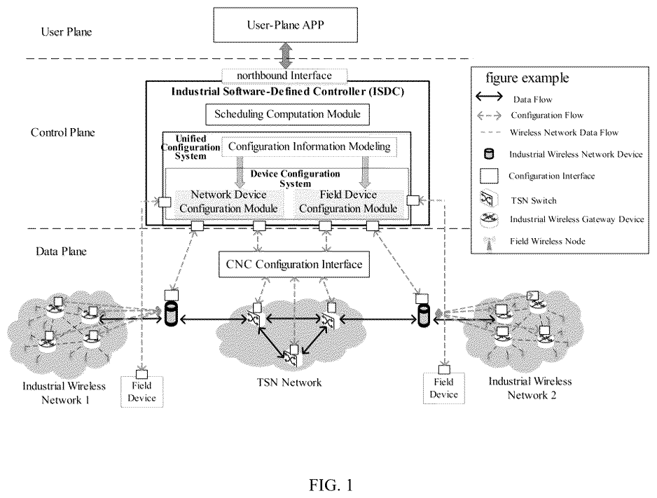

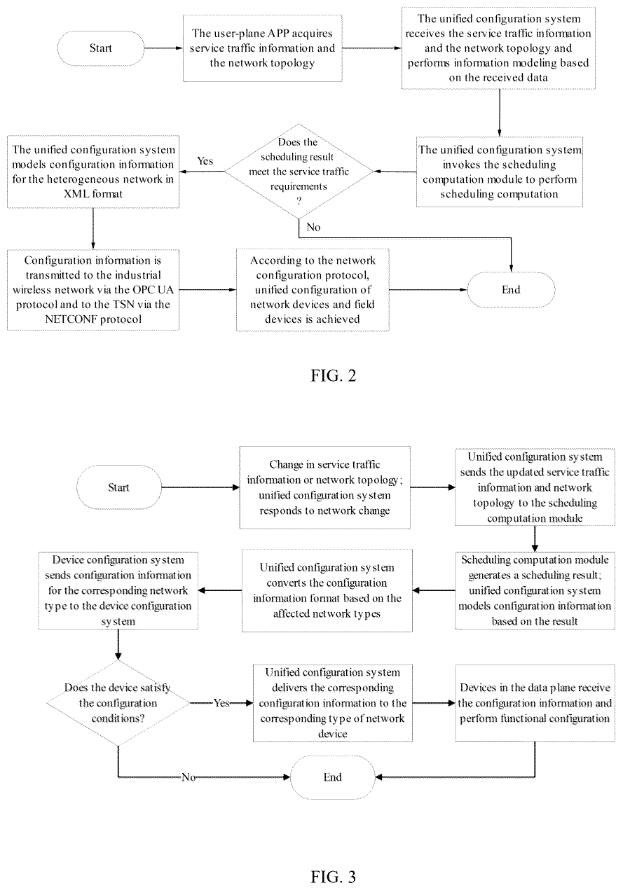

FIG. 1 illustrates the unified configuration architecture for a heterogeneous network integrating an industrial wireless network and a Time-Sensitive Networking (TSN), as proposed in the present solution.

This architecture is structured top-down into three layers: a user plane, a control plane, and a data plane. Centered around the control plane, the configuration architecture follows a north-south directional logic, where the control plane interacts with the user plane and the data plane through a northbound interface and a configuration interface, respectively. The functional roles of each layer in the unified configuration architecture are as follows:

The user plane comprises various applications (APPs) based on Software-Defined Networking (SDN), which are capable of acquiring service traffic requirements and implementing corresponding network management functions. The user-plane application interacts and manages the control plane and the data plane by invoking the northbound interface.

The control plane primarily consists of an industrial software-defined controller (ISDC), which includes a unified configuration system and a scheduling computation module. The present solution focuses primarily on the design and implementation of the unified configuration system within the industrial software-defined controller. The control plane communicates with the data plane via the configuration interface and with the user plane via the northbound interface. The unified configuration system manages and configures devices in the data plane through the configuration interface.

The data plane consists of industrial wireless network and TSN network devices, including field wireless nodes, industrial wireless routing devices, industrial wireless gateway devices, TSN network devices, and other field devices. The field devices, field wireless nodes, and industrial wireless routing devices refer to devices in the industrial wireless network that transmit data. The industrial wireless gateway devices and TSN switches are responsible for aggregating and forwarding industrial field data.

The fundamental tasks of the two types of interfaces are as follows:
Northbound interface: provides an interface for the user-plane application to access and manage the network, facilitating unified scheduling of resources; it serves as a service interface oriented toward the user plane;
Configuration interface: provides an interface that supports management and configuration functions for field devices and network devices; it serves as the configuration information exchange interface between the control plane and the data plane.

### 2. Unified Configuration Scheme for a Heterogeneous Network Integrating an Industrial Wireless Network and a Time-Sensitive Networking

### 2.1 Scheme Overview

The present scheme proposes a unified configuration method for a heterogeneous network integrating an industrial wireless network with a Time-Sensitive Networking (TSN), aiming to address the limitations of traditional configuration approaches in meeting diverse service requirements within heterogeneous networks.

With respect to the unified configuration architecture shown in FIG. 1, after the user-plane application inputs the service traffic information, the unified configuration system acquires the service traffic information and network topology information via the northbound interface. To facilitate scheduling computation by network bandwidth and load optimization algorithms, the unified configuration system performs modeling of the service traffic information and the network topology. The scheduling computation module contains multiple algorithms for optimizing network bandwidth and load. By parsing parameters from the service traffic information model, the scheduling computation module performs scheduling computation and produces a scheduling result.

The unified configuration system then models the configuration information based on the scheduling result and delivers the configuration information to the network devices. In accordance with a network configuration protocol, unified configuration of both network devices and field devices is achieved. Within the heterogeneous network, configuration methods suited to the characteristics of TSN and industrial wireless networks are respectively designed.

For the TSN network portion, the unified configuration system performs YANG model-based configuration modeling for TSN network devices. Functional configuration of the TSN network devices is implemented using the NETCONF network management protocol. The TSN network configuration includes gate control list (GCL) configuration, topology information acquisition, and load status retrieval of TSN network devices.

For the industrial wireless network portion, an OPC UA client is deployed in the unified configuration system, and an OPC UA server is deployed in the industrial wireless gateway device. The unified configuration system transmits the configuration information to the industrial wireless gateway device using an OPC UA transmission mechanism. Finally, the configuration information is structured in an XML format to realize unified configuration of the heterogeneous network.

Accordingly, the steps of the unified configuration scheme for a heterogeneous network integrating an industrial wireless network with a Time-Sensitive Networking (TSN) are as follows:
Step 1: the user-plane application acquires service traffic information and a network topology;
Step 2: the user-plane application transmits the service traffic information to the control plane via a northbound interface, and obtains the network status of the data plane via the northbound interface;
Step 3: the unified configuration system performs modeling of the service traffic information and the network topology, the scheduling computation module parses the service traffic information model, performs scheduling computation, and obtains a scheduling result;
Step 4: a network device configuration method is designed for both the industrial wireless network and the TSN network to enable configuration of network devices in the heterogeneous network;
Step 5: configuration information for the heterogeneous network is designed in an XML format;
Step 6: the unified configuration system delivers the configuration information to configure the network devices and field devices in the heterogeneous network.

### 2.2 Scheme Design

### 2.2.1 Acquiring Service Traffic Information and Network Topology Via the User-Plane Application

The interactive interface of the user-plane application may acquire service traffic information and a heterogeneous network topology either through manual user input or via a user-defined configuration protocol. The service traffic information includes a network protocol identifier, a traffic frame length, a traffic period, a jitter constraint, and a delay constraint. The user-plane application is further capable of constructing the heterogeneous network topology, which serves as input condition information for performing scheduling computation.

### 2.2.2 Requirement Analysis and Design of the Northbound Interface in the Unified Configuration System

The user-plane application establishes a connection with an industrial software-defined controller in the control plane via a northbound interface, which enables programming, deployment, and configuration of the heterogeneous network. In addition to transmitting service traffic requirements, the northbound interface must also be capable of retrieving network status information from the data plane. The northbound interface proposed in this scheme is designed based on the unified configuration of heterogeneous networks, fully considering the characteristics of the networks, and integrating the management and control of industrial wireless networks and Time-Sensitive Networking to support functional interaction and information exchange between the user plane and the control plane within the unified configuration architecture.

The northbound interface of the unified configuration system is designed to meet the following requirements:
(1) to facilitate integration with other software systems by allowing easy invocation of the northbound interface, enabling flexible interaction between third-party software and the unified configuration system;
(2) to provide a scheduling algorithm selection interface, a scheduling algorithm computation interface, a configuration information query interface, a scheduling result upload interface, a network topology query interface, a service traffic variation notification interface, and a network topology variation notification interface, thereby fulfilling the unified configuration requirements of heterogeneous networks.

The northbound interface in this scheme is designed using standard interface methods such as GET and POST. According to the functionality of each interface, the unified configuration system processes access requests by receiving request parameters, executing the corresponding logical operations, and returning a status response message based on the result of the access.

The API address prefix is defined as: http://localhost:8088. A detailed explanation of the northbound interfaces in the unified configuration system is provided in Table 1:

TABLE 1
Description of Northbound Interface Design

| | Resource | Request | Interaction |
|---|---|---|---|
| Interface Name | identifier | Method | Format |
| Scheduling algorithm | /UCS/selectalgo | POST | JSON |
| selection interface | | | |
| Scheduling algorithm | /UCS/startalgo | GET | JSON |
| computation interface | | | |
| Configuration information | /UCS/queconinfo | POST | JSON |
| query interface | | | |
| Scheduling result upload | /UCS/postconinfo | POST | JSON |
| interface | | | |
| Network topology query | /UCS/quetopo | GET | JSON |
| interface | | | |
| Service traffic variation | /UCS/streamchange | POST | JSON |
| notification interface | | | |
| Network topology | /UCS/topochange | POST | JSON |
| variation notification | | | |
| interface | | | |

As an example, the design of the scheduling algorithm selection interface is described as follows:

The unified configuration system provides a POST interface at the URL {http://localhost:8088/UCS/selectalgo}. The request parameter is: {“message”: “algoSelect”, “algoName”: “MPC”}. A normal response returns: {“msg”: “success”, “code”: 0}. An error response returns: {“msg”: “error”, “code”: 1}. In this context, the parameter algoName corresponds to the English name of the scheduling algorithm to be selected. For example, if the request parameter algoName is set to “MPC”, it indicates that the MPC algorithm in the scheduling computation module is selected, thereby enabling computation using a specific scheduling algorithm.

By designing a set of northbound interfaces between the user plane and the control plane, data and information exchange between the two planes can be realized. The unified configuration system can perform operations such as information querying and scheduling computation based on the received service traffic information, while the user-plane application gains visibility and control over the global network status.

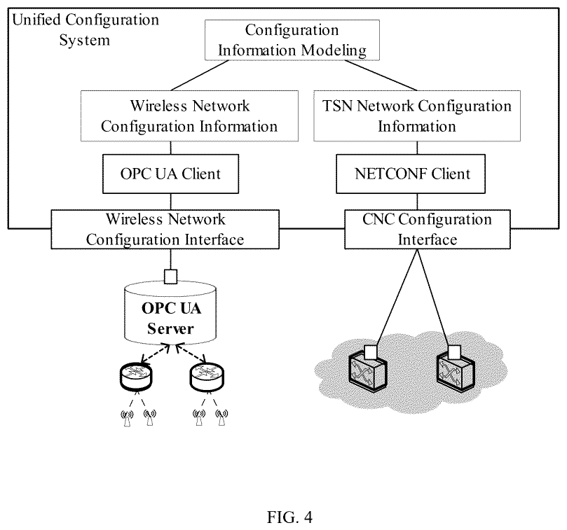

This scheme further proposes a dynamic configuration mechanism based on changes in the network. When there is an increase or decrease in service traffic within the heterogeneous network, or when changes occur in the network topology, static configuration information in the devices may no longer satisfy the transmission requirements of the service traffic. In such cases, the unified configuration system must respond to network changes and invoke the scheduling computation module to update configuration information dynamically. When service traffic information or network topology changes on the user plane, the notification interface in the unified configuration system is invoked. The unified configuration system responds to the change request and begins recalculating the static configuration information. A flowchart of the dynamic configuration mechanism for the heterogeneous network is shown in FIG. 3.

### 2.2.3 Modeling of Service Traffic Information and Network Topology

In the industrial software-defined controller, the unified configuration system and the scheduling computation module function as two essential components that enable optimal transmission of service traffic within a heterogeneous network. The unified configuration system must supply the scheduling computation module with both the service traffic information and the network topology. The scheduling computation module can then accurately parse this data and use it as input to compute the traffic scheduling result under the current network topology. Based on the scheduling result, the unified configuration system generates configuration information, which is delivered to the devices to ensure reliable transmission of the service traffic.

### (1) Modeling of Service Traffic Information

The user-plane application transmits the service traffic information to the unified configuration system through a service traffic information module interface. Given the coexistence of multiple types of service traffic in the heterogeneous network formed by the integration of industrial wireless networks and TSN, the unified configuration system must perform semantic-level modeling of the service traffic information to construct a service traffic information model.

The unified configuration system constructs the service traffic information model using a JSON format. JSON is a lightweight, text-based data interchange format that is language-independent and structured in key-value pairs. This structure facilitates flexible data operations such as insertion, modification, querying, and deletion. The unified configuration system encapsulates the network protocol identifier, traffic frame length, traffic period, jitter constraint, and delay constraint into the service traffic information model. Once encapsulated, the service traffic information model significantly enhances the semantic interoperability capabilities of the unified configuration system.

The key definitions and descriptions used in the service traffic information model are shown in Table 2.

TABLE 2
Key Definitions in the Service Traffic Information Model

| Key | Description | Key | Description |
|---|---|---|---|
| TSN_{—} | TSN network | TSN_StrNetDela | Maximum end-to- |
| StrNetInfo | protocol | | end delay for |
| | identifier | | TSN traffic |
| WN_{—} | Industrial | TSN_StrNetJitter | Maximum end-to- |
| StrNetInfo | wireless | | end jitter for TSN |
| | network traffic | | traffic |
| | identifier | | |
| TSN_{—} | TSN traffic | WN_{—} | Superframe |
| StrNetFrame | frame length | StrSupframelength | length in |
| | | | industrial |
| | | | wireless network |
| TSN_{—} | Priority level of | WN_StrNetPriority | Priority level of |
| StrNetPriority | TSN-side | | industrial wireless |
| | traffic | | network traffic |
| TSN_{—} | Period of TSN- | WN_StrNetType | Data stream type |
| StrNetPeriod | side traffic | | in the industrial |
| | | | wireless network |

By analyzing the service traffic information in both the Time-Sensitive Networking and the industrial wireless network, the service traffic information is modeled accordingly. Traffic parameters such as the network protocol identifier, frame length, period, maximum jitter, and delay are defined as “Keys,” and their corresponding attribute values are assigned as “Values.” This key-value pair structure allows for flexible operations such as the addition of traffic characteristics, jitter constraints, and delay constraints. According to the TSN standard, traffic is classified into eight priority levels based on traffic type and service requirements, with TSN-side traffic priority values ranging from 0 to 7. On the industrial wireless network side, traffic may also be divided into multiple priority levels in accordance with relevant standards and may further include parameters such as superframe length and protocol identifier.

### (2) Modeling of Network Topology

In heterogeneous network load optimization and scheduling, the network topology serves as a critical input for the scheduling algorithm module, as it enables path planning for service traffic transmission. Therefore, it is also necessary to model the network topology as structured information. In this scheme, the network topology is represented as a directed graph G=(V, E), and the connection relationships within the topology are stored in JSON format. Each device in the network topology is assigned a unique IP address, and devices are distinguished by their respective IPs. By acquiring the connection relationships between devices, a JSON-based topology model is constructed. The definitions and explanations of the symbols used in the JSON topology model are shown in Table 3.

TABLE 3
Symbol Definitions in the JSON Topology
Model for a Heterogeneous Network

| Parameter Name | Parameter Type | Description |
|---|---|---|
| viewDevLinkList | string | Primary key ID |
| SourceDevIp | string | Source device IP address |
| TargetDevIp | string | Target device IP address |
| SouDevPort | Integer | Source device port |
| TarDevPort | Integer | Target device port |
| SouDevPortEnable | string | Enable status of the source device |
| | | port |
| TarDevPortEnable | string | Enable status of the target device |
| | | port |

Using this JSON structure, the connection relationships between devices in the network can be obtained. For example, if the source device IP is 192.168.0.1, the target device IP is 192.168.0.2, the source device port 1 is connected to the target device port 2, and both ports have their enable status set to “Enable,” then the two devices are capable of transmitting service traffic between them.

Example of Topology Connection Relationship:
Port-Level Connection Between Two Devices

“viewDevLinkList”:
[{
“SourceDevIp”: “192.168.0.1”,
“TargetDevIp”: “192.168.0.2”,
“SouDevPort”: 1,
“TarDevPort”: 2,
“SouDevPortEnable”:“Enable”,
“TarDevPortEnable”:“Enable”
}]

By parsing the topology connection relationships among the network devices, the connection relationships between devices can be determined, thereby allowing construction of the input directed graph G=(V, E), where V represents the set of nodes and E represents the set of edges. Based on this model, the transmission path from the sending end to the receiving end within the network can be derived.

### 2.2.4 Design of Configuration Methods for Heterogeneous Networks

In a heterogeneous network, configuration methods suited to the respective characteristics of the Time-Sensitive Networking (TSN) and the industrial wireless network are separately designed. This scheme primarily focuses on designing the configuration method for industrial wireless network devices, while also integrating a TSN device configuration system to achieve unified configuration of devices across the heterogeneous network. FIG. 4 illustrates a schematic diagram of the configuration of network devices in the industrial wireless network and the TSN.

In the industrial wireless network, the network manager for field wireless nodes is typically located in the industrial wireless gateway device. The gateway device is responsible for aggregating data collected by the field wireless nodes within its management domain and for allocating network resources. It can also configure network resources for field wireless nodes, particularly with respect to superframe duration and timeslot duration.

This scheme utilizes the data transmission mechanism and robust information modeling capabilities of OPC UA, which provide comprehensive semantic representation and good extensibility across various types of wireless network managers. An OPC UA client/server model is established between the unified configuration system and the industrial wireless network. Configuration information is modeled using OPC UA and transmitted for effective information interaction between the configuration system and the devices. Specifically, the unified configuration system and the industrial wireless gateway device are configured with an OPC UA client and an OPC UA server, respectively. The OPC UA server provides an access interface to the client in the form of a service, and a connection is established via the UDP protocol to facilitate information exchange.

Due to the limited hardware resources of the industrial wireless gateway device, direct transplantation of a full OPC UA server is not feasible. To reduce resource consumption on such constrained hardware, this scheme adopts a lightweight OPC UA server solution, retaining only the core functions by eliminating unnecessary services. Once the OPC UA server is deployed, the OPC UA client communicates with the OPC UA server via the OPC UA protocol and transmits wireless network configuration information from the unified configuration system to the industrial wireless gateway device.

For TSN network configuration, configuration management is performed in accordance with the IEEE 802.1Qcc standard using the NETCONF network management protocol. Data modeling is performed via the YANG (Yet Another Next Generation) model. A NETCONF connection is established between the unified configuration system and the TSN, with the NETCONF client and server communicating via an SSH protocol. The SSH protocol enables transmission of XML configuration information. The unified configuration system transmits the XML configuration information to the TSN network device, and the NETCONF server verifies and parses the XML configuration information. Based on the parsed result, the server executes the corresponding operations to complete the TSN device configuration and returns a status message to the NETCONF client.

### 2.2.4.1 Modeling of Industrial Wireless Network Devices

The unified configuration system performs modeling of the scheduling computation result, which first requires information modeling of network devices within the industrial wireless network. Based on the functions and characteristics of the industrial wireless network devices, the corresponding object class nodes are determined. After defining the object types, the information model is instantiated and described using XML.

Taking the industrial wireless gateway device as the modeling object, the instantiation of the information model is examined. Model instantiation refers to converting an abstract information model into actual data objects. The static attribute set primarily includes basic information of the industrial wireless gateway device (e.g., model type, device IP address), while the dynamic attributes include functional configuration parameters of the gateway, such as superframe duration and timeslot duration.

The application of the information model involves this instantiation process, which mainly consists of instantiating various information objects within the static attribute set and the process attribute set of the industrial wireless gateway device. Essentially, it involves populating specific data into the various attributes defined in the information model of the industrial wireless gateway device.

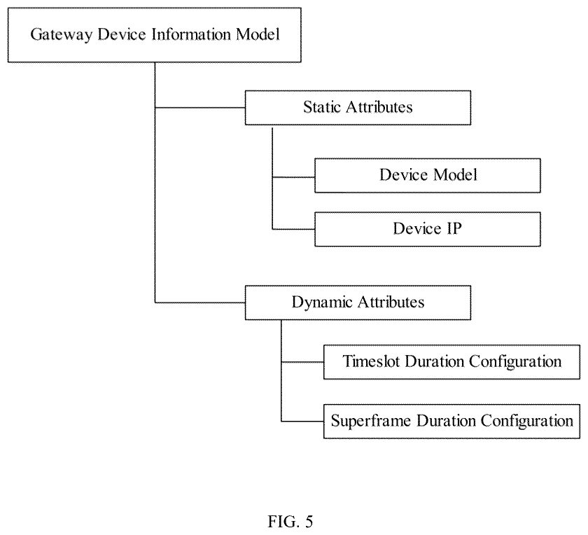

FIG. 5 illustrates the information model designed for the industrial wireless gateway device, which includes a static attribute set and a dynamic attribute set. The basic information of the industrial wireless network comprises the gateway model and the device IP address. The gateway model includes the basic model information of the gateway; the supported protocols refer to the set of protocols required for the gateway to operate properly; and the device IP represents the gateway's IP address, which enables identification of the device via its IP.

In timeslot allocation within the industrial wireless network, an important parameter is the number of timeslots within a superframe. Accordingly, the resource configuration parameters mainly include the superframe duration and the timeslot duration. The static attributes can be used to externally provide device information, enabling access to the gateway model, IP address, and other device-related details. The dynamic attributes enable read and write operations for parameters such as the superframe duration and timeslot duration. The configuration of dynamic attributes includes defining input and output parameters related to the superframe and timeslot configuration.

In this scheme, an OPC UA server is developed on the industrial wireless gateway device, and the above-described model is loaded into the OPC UA server's address space. The XML description file generated during the testing process is mapped to the OPC UA server's address space. The OPC UA server is then executed, and an OPC UA client is used to access the server's address space and retrieve the full content of the information model. During testing of the information model, changes in nodes can be used to determine whether the model has been successfully implemented.

To perform OPC UA information modeling more effectively on the industrial wireless network device, the information model must be instantiated in accordance with the structure of a standard address space. In this scheme, third-party OPC UA modeling tools—such as Ua Modeler—are employed to construct and instantiate the information model of the industrial wireless gateway device. The resulting XML description file corresponding to the information model is imported into the address space of the OPC UA server.

### 2.2.4.2 Modeling of TSN Network Devices

NETCONF, a network configuration management protocol based on Extensible Markup Language (XML), defines configuration information in XML format and uses a Remote Procedure Call (RPC) mechanism to facilitate communication between the unified configuration system and TSN network devices. The unified configuration system transmits XML configuration information to a TSN network device, which receives the XML configuration and verifies its validity using a YANG model. If the configuration information passes validation, the TSN network device parses the data from the XML and performs the corresponding functional configuration. Upon completing the TSN network configuration, the TSN network device sends a status response message back to the unified configuration system.

### 2.2.5 Design of XML-Based Configuration Information for Heterogeneous Networks

### (1) Configuration Information for Industrial Wireless Networks

Once the information model of the gateway device has been established, it is described using XML. Through the XML file, the basic information of the gateway device can be obtained, and the various attributes within OPC UA, along with their references and inheritance relationships, can be clearly defined. This facilitates consistent recognition and parsing of the same information model across different environments and programming languages. The information model supports transmission, reading, and writing across different systems, enabling configuration information to be delivered via the information interface exposed by the OPC UA server.

In this scheme, the configuration information for the gateway device is designed in XML format, with a focus on configuring the superframe duration and timeslot duration of the gateway device.

Example XML configuration for a WIA-PA wireless
network: configuring the superframe duration
to 1 and the timeslot duration to 10.

```
<rpc
  xmlns=“urn:ietf:params:xml:ns:netconf:base:1.0” message-id=“1”>
  <?xml version=“1.0” encoding=“utf-8”?>
  <edit-config>
    <target>
      <running/>
    </target>
    <config>
      <iface-control-lists
        xmlns=“wsnconxml:wsn:params:xml:ns:yang:wsncon”>
        <control-lists>
          <ifaceName>wia_pa</ifaceName>
          <index>0</index>
          <superframe>1</superframe>
          <specify-operation>set</specify-operation>
        </control-lists>
        <control-lists>
          <ifaceName>wia_pa</ifaceName>
          <slot>10</slot>
          <specify-operation>set</specify-operation>
        </control-lists>
      </iface-control-lists>
    </config>
  </edit-config>
</rpc>
```

### (2) Configuration Information for TSN

In this scheme, the configuration model of TSN network devices is constructed using a YANG model. The unified configuration system populates the scheduling computation results into the YANG model and stores and transmits the scheduling data using XML. Specifically, an XML configuration is designed for the gate control list (GCL) of the TSN network devices. The XML configuration can be updated according to the scheduling computation results, and the updated configuration information is delivered via the CNC configuration interface, thereby enabling the configuration of TSN network devices to be updated accordingly.

Example XML configuration for GCL: configuring timeslots
of 10 us and 20 us for switch ports 1 and 2, respectively

```
<rpc
  xmlns=“urn:ietf:params:xml:ns:netconf:base:1.0” message-id=“1”>
  <?xml version=“1.0” encoding-“utf-8”?>
  <edit-config>
    <target>
      <running/>
    </target>
    <config >
      <iface-control-lists
        xmlns=“tsngalxml:tsn:params:xml:ns:yang:tsngal”>
        <control-lists>
          <ifaceName>tsnport 1</ifaceName>
          <index>0</index>
          <queue>0,1,2,3,4,5,6,7</queue>
          <operate>enable</operate>
          <time-interval>10</time-interval>
          <specify-operation>set</specify-operation>
        </control-lists>
        <control-lists>
          <ifaceName>tsnport 2</ifaceName>
          <index>1</index>
          <queue>0,1,2,3,4,5,6,7</queue>
          <operate>enable</operate>
          <time-interval>20</time-interval>
          <specify-operation>set</specify-operation>
        </control-lists>
      </iface-control-lists>
    </config>
  </edit-config>
</rpc>
```

### 2.2.6 Configuration of Network Devices and Field Devices in a Heterogeneous Network

### (1) Configuration of Industrial Wireless Network Devices and Field Devices

The industrial wireless network mainly includes three types of devices: industrial wireless gateway devices, industrial wireless routing devices, and field wireless nodes. Functional configuration of these three types of devices is performed to meet the transmission requirements of service traffic.

Among them, the industrial wireless gateway device, as a network device, establishes a connection with the unified configuration system via the OPC UA transmission mechanism, and receives industrial wireless network configuration information sent from the unified configuration system. After receiving the configuration information, the industrial wireless gateway device generates a routing table, a superframe table, and a link table. It sends configuration frames to the industrial wireless routing devices within the network. The industrial wireless routing devices then transmit beacon frames and forward the superframe configuration information to the field wireless nodes, which in turn complete their superframe configuration tasks based on the received information.

### (2) Configuration of Time-Sensitive Networking Devices and Field Devices

Time-Sensitive Networking (TSN) devices mainly consist of switches that comply with TSN technical standards. These switches can be configured for gate control lists (GCLs), port enable states, and other functionalities. XML configuration information is delivered to the switches, where a NETCONF server is deployed to verify and parse the information. Based on the parsed results, the switches perform the corresponding configuration operations. Network devices in the TSN network forward the configuration information to the TSN field devices. Upon receiving the configuration information, each TSN field device verifies its contents. If the configuration information is intended for that device, it proceeds to parse and execute the corresponding configuration actions. If the configuration is not addressed to that device, the information is discarded without further processing.

It should be noted that the above-described embodiments are merely illustrative of the technical solutions of the present invention and should not be construed as limiting. Although the present invention has been described in detail with reference to preferred embodiments, those of ordinary skill in the art will appreciate that modifications or equivalent substitutions may be made to the technical solutions without departing from the spirit and scope of the invention. All such modifications and equivalents should be considered as falling within the scope of the claims of the present invention.

What is claimed is:

1. A unified configuration method for integrating an industrial wireless network with a Time-Sensitive Networking (TSN), comprising:
S1: establishing a user-plane application for acquiring service traffic information and a network topology;
S2: transmitting the service traffic information from the user-plane application to a control plane via a northbound interface, and retrieving a data-plane network status via the northbound interface;
S3: modeling the service traffic information and the network topology using a unified configuration system, parsing a traffic information model via a scheduling computation module, performing scheduling computation, and obtaining a scheduling result;
S4: designing a network device configuration method for the industrial wireless network and the TSN to enable configuration of network devices in a heterogeneous network;
S5: designing configuration information for the heterogeneous network based on an XML format; and
S6: delivering the configuration information from the unified configuration system to configure the network devices and field devices in the heterogeneous network.

2. The unified configuration method according to claim 1, wherein S1 comprises:
providing an interactive interface in the user-plane application for acquiring the service traffic information and the heterogeneous network topology via manual user input or a user-defined configuration protocol;
wherein the service traffic information comprises a network protocol identifier, the traffic frame length, the traffic period, the jitter constraint, and the delay constraint;
and wherein the user-plane application is further configured to construct the heterogeneous network topology as input condition information for performing the scheduling computation.

3. The unified configuration method according to claim 2, wherein S2 comprises:
establishing a connection between the user-plane application and an industrial software-defined controller in the control plane via the northbound interface, the user-plane application being configured to program, deploy, and configure the heterogeneous network;
wherein the northbound interface is configured to support transmission of the service traffic requirements and retrieval of the network status information from the data plane;
designing the northbound interface of the unified configuration system to satisfy the following requirements:
(1) enabling integration with external software systems;
(2) providing interfaces including a scheduling algorithm selection interface, a scheduling algorithm execution interface, a configuration information query interface, a scheduling result upload interface, a network topology query interface, a service traffic variation notification interface, and a network topology variation notification interface;
wherein an API address prefix is defined as http://localhost:8088, and the northbound interface of the unified configuration system is further configured with:
the scheduling algorithm selection interface identified by /UCS/selectalgo, using a POST request method and a JSON interaction format;
the scheduling algorithm execution interface identified by /UCS/startalgo, using a GET request method and the JSON interaction format;
the configuration information query interface identified by /UCS/queconinfo, using a POST request method and the JSON interaction format;
the scheduling result upload interface identified by /UCS/postconinfo, using a POST request method and the JSON interaction format;
the network topology query interface identified by /UCS/quetopo, using a GET request method and the JSON interaction format;
the service traffic variation notification interface identified by /UCS/streamchange, using a POST request method and the JSON interaction format; and
the network topology variation notification interface identified by /UCS/topochange, using a POST request method and the JSON interaction format.

4. The unified configuration method according to claim 3, wherein S3 comprises:
(1) modeling the service traffic information by using a JSON format in the unified configuration system to construct a service traffic information model;
encapsulating a network protocol identifier, a traffic frame length, a traffic period, a jitter constraint, and a delay constraint included in the service traffic information into the service traffic information model, such that the encapsulated model improves semantic interoperability of the unified configuration system;
analyzing the service traffic information in the Time-Sensitive Networking and the industrial wireless network to define the network protocol identifier, the frame length, the period, the maximum jitter, and the delay as “Key”, and assigning corresponding attribute values as “Value”; wherein the TSN traffic is categorized into eight priority levels according to traffic type and requirements, such that TSN-side traffic priority values range from 0 to 7; and the industrial wireless network traffic is classified into multiple priority levels based on relevant standards, further including a superframe length and protocol identifier information;
(2) modeling the network topology by processing the network topology as a directed graph G=(V, E) and storing connection relationships in a JSON format;
wherein each device in the network topology has a unique IP address and is distinguishable via the device IP, and the connection relationships between devices are collected to construct a JSON-based topology model;
wherein parameters in the JSON topology model comprise:
a viewDevLinkList of type string indicating a primary key ID;
a SourceDevIp of type string indicating a source device IP;
a TargetDevIp of type string indicating a target device IP;
a SouDevPort of type Integer indicating a source device port;
a TarDevPort of type Integer indicating a target device port;
a SouDevPortEnable of type string indicating a source port enable state; and
a TarDevPortEnable of type string indicating a target port enable state;
parsing the connection relationships among the network devices to construct the directed graph G=(V, E), where V is a set of nodes and E is a set of edges, to determine a transmission path from a sending end to a receiving end in the network.

5. The unified configuration method according to claim 4, wherein S4 comprises:
establishing an OPC UA client/server connection between the unified configuration system and the industrial wireless network, modeling the configuration information using an OPC UA protocol, and transmitting data to enable information interaction between the configuration system and devices;
establishing an OPC UA client in the unified configuration system and an OPC UA server in an industrial wireless gateway device, wherein the OPC UA server provides an access interface as a service to the OPC UA client, and a connection is established using a UDP protocol to enable information exchange;
after deployment of the OPC UA server, performing information exchange between the OPC UA client and the OPC UA server via the OPC UA protocol, and transmitting wireless network configuration information from the unified configuration system to the industrial wireless gateway device;
for configuring the TSN network, performing configuration management of TSN network devices using a NETCONF network management protocol in accordance with IEEE 802.1Qcc standard, and modeling data using a YANG (Yet Another Next Generation) model;
establishing a NETCONF connection between the unified configuration system and the TSN network, wherein a NETCONF client and a NETCONF server establish the NETCONF connection via an SSH protocol, the SSH protocol being used to transmit XML-based configuration information;
transmitting the XML-based configuration information from the unified configuration system to the TSN network device, verifying and parsing the XML-based configuration information at the NETCONF server, performing corresponding operations to configure the TSN network device, and returning a status message to the NETCONF client.

6. The unified configuration method according to claim 5, wherein S5 comprises:
(1) after establishing a gateway device information model, describing the information model using XML to obtain basic information of the gateway device from an XML file, and defining various attribute information as well as reference and inheritance relationships in OPC UA;
wherein the information model is configured to support transmission, reading, and writing across different systems, and configuration information is delivered by accessing an externally exposed information interface of the OPC UA server;
(2) modeling a configuration model for TSN network devices using a YANG model, establishing the network device configuration model, populating the scheduling result into the YANG model by the unified configuration system, and storing and transmitting the scheduling result in an XML format.

7. The unified configuration method according to claim 6, wherein S6 comprises:
(1) configuring the industrial wireless network devices and the field devices, wherein the industrial wireless network comprises an industrial wireless gateway device, an industrial wireless routing device, and a field wireless node, and the unified configuration system is configured to perform functional configuration of the three device types to satisfy service traffic transmission requirements;
wherein the industrial wireless gateway device serves as a network device, and the unified configuration system establishes a connection with the industrial wireless gateway device via an OPC UA transmission mechanism to transmit the industrial wireless network configuration information;
after receiving the configuration information, the industrial wireless gateway device generates a routing table, a superframe table, and a link table, and transmits configuration information frames to the industrial wireless routing device;
the industrial wireless routing device transmits a beacon frame and superframe configuration information to the field wireless node, and the field wireless node performs a superframe configuration task based on the configuration information;
(2) configuring the Time-Sensitive Networking devices and the field devices, wherein the TSN devices comprise a switch supporting TSN technical standards, and the switch is configured with a gate control list and a port enablement state;
the XML configuration information is transmitted to the switch, and a NETCONF server deployed in the switch verifies and parses the XML configuration information, then performs functional configuration based on the parsed results;
a network device in the TSN network forwards field device configuration information to a TSN field device, the TSN field device verifies the configuration information, and if the configuration information is addressed to the TSN field device, the device parses and applies the configuration;
if the configuration information is not addressed to the TSN field device, the information is discarded without processing.
